(19) United States
(12) Patent Application Publication
(10) Pub. No.: US 2020/0147483 A1
(43) Pub. Date: May 14, 2020

(54) INTERACTIVE GAMING SYSTEM

(71) Applicant: Primax Electronics Ltd., Taipei (TW)

(72) Inventors: Shou-Kuo Tai, Taipei (TW); Yu-Chiang Lin, Taipei (TW); Wun-Ting Jheng, Taipei (TW); Hsin-Ju Teng, Taipei (TW)

(21) Appl. No.: 16/286,145

(22) Filed: Feb. 26, 2019

(30) Foreign Application Priority Data
Nov. 9, 2018 (TW) 107139892

(51) Int. Cl. A63F 13/213; G06K 9/00; A63F 13/215; A63F 13/2145; A63F 13/235

(52) U.S. Cl. CPC A63F 13/213; G06K 9/00335; G06F 3/04883; A63F 13/2145; A63F 13/235; A63F 13/215

(57) ABSTRACT

An interactive gaming system includes an electronic device, an image capturing device, a display device and a recognition module. The electronic device executes a gaming software. The image capturing device shoots the user to acquire a user image. The user image is shown on the display device. The electronic device and the image capturing device can acquire the operating command from the user. The recognition module recognizes the operating command. According to the recognition result of the recognition module, the game character in the gaming software performs a corresponding action. Consequently, the user image and the game character are simultaneously shown on the display device. Moreover, the game character can perform the corresponding action according to the operating command from the user.

### FIELD OF THE INVENTION

The present invention relates to a gaming system, and more particularly to a gaming system for playing games by interacting with a game console.

### BACKGROUND OF THE INVENTION

In the early stage, the gaming software is installed in a cassette or an optical disc, and a dedicated game console is needed to execute the gaming software. For example, the Nintendo game consoles in the earliest stage and the well-received Play Stations 1 to 4, Nintendo's Wii and Switch in the later stage are the examples of the dedicated game consoles. With the advancement of science and technology, users are increasingly pursuing the variability and interesting efficacy of games. Therefore, the game manufactures make efforts in developing new games in order to gain the favor of users.

Most of these game consoles require input interfaces such as joysticks or operation controllers (also known as handlebar) to input commands for playing games. In case that an electronic-sports game is played through a computer host, it is necessary to input commands through the input interface such as a mouse or a keyboard. In case that a computer game is played through a handheld electronic device such as a smart phone or a tablet computer, a touch screen is used as an input interface and commands are inputted into the handheld electronic device in a touch control manner. In other words, various input devices are required to input commands to play games.

Take a pet game as an example. FIG. 1 is a schematic diagram illustrating a screen image when a gaming software is executed in a conventional game console. In FIG. 1, a conventional game console 1 is shown. The game console 1 comprises a touch screen 10. When a gaming software (not shown) is executed in the game console 1, a screen image 100 corresponding to the gaming software is displayed on the touch screen 10. The screen image 100 includes a game character 101 (i.e., a pet), a status display interface 102 and a control interface 103. The status display interface 102 includes a player status region 1021 and a pet status region 1022. The control interface 103 includes a clothing replacement option 1031, a shopping option 1032, a beautifying option 1033 and other appropriate options. The user may touch the touch screen 10 to select an option of the control interface 103 to play the game. For example, the user may select the clothing replacement option 1031 to provide clothing (e.g., the hat as shown in FIG. 1) in order to change the style of the game character 101. The user may select the shopping option 1032 to increase the clothing or food of the game character 101. Moreover, the user may select the beautifying option 1033 to bathe the game character 101 or trim the hair of the game character 101.

As mentioned above, the conventional game console 1 still needs to use the touch screen 10 as an input interface to play the game. For enhancing the interesting efficacy of playing games, the present invention provides an interactive game system without the need of using an input device.

### SUMMARY OF THE INVENTION

The present invention provides an interactive game system without the need of using an input device.

In accordance with an aspect of the present invention, there is provided an interactive gaming system. The interactive gaming system includes an electronic device, an image capturing device, a display device and a recognition module. The electronic device executes a gaming software and receives an operating command from a user. The image capturing device is in communication with the electronic device. The image capturing device shoots a scene to acquire a scene image, or the image capturing device shoots the user to acquire a user image. The display device is connected with the electronic device. The scene image, the user image and a game character corresponding to the gaming software are displayed on the display device. The recognition module is connected with the electronic device. After the recognition module receives and recognizes the operating command, an operating signal corresponding to the operating command is transmitted from the recognition module to the electronic device, and the game character in the scene image performs a corresponding action according to the operating signal.

In an embodiment, the recognition module includes a database, and plural predetermined commands are stored in the database. When the recognition module receives the operating command, the recognition module compares the operating command with the plural predetermined commands in the database. If the recognition module judges that the operating command complies with at least one of the plural predetermined commands, the operating signal corresponding to the operating command is transmitted from the recognition module to the electronic device. If the recognition module judges that the operating command does not comply with all of the plural predetermined commands, the recognition module issues a prompt signal to the electronic device.

From the above descriptions, the present invention provides the interactive gaming system. The image capturing device acquires the user image corresponding to the user. The user image is shown on the display device. Moreover, the operating command from the user is obtained through the electronic device or the image capturing device. Afterwards, the operating command is recognized by the recognition module. According to the recognition result of the recognition module, the game character in the gaming software performs a corresponding action. Consequently, the user can see that the user image and the game character are simultaneously shown on the same screen image of the display device. Moreover, the game character can perform the corresponding action according to the sound or gesture of the user. When compared with the conventional technology of using the joystick or the operation controller to play games, the interactive gaming system of the present invention allows the user to have the feel in the virtual situation and provides highly interesting efficacy to the user.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a screen image when a gaming software is executed in a conventional game console;

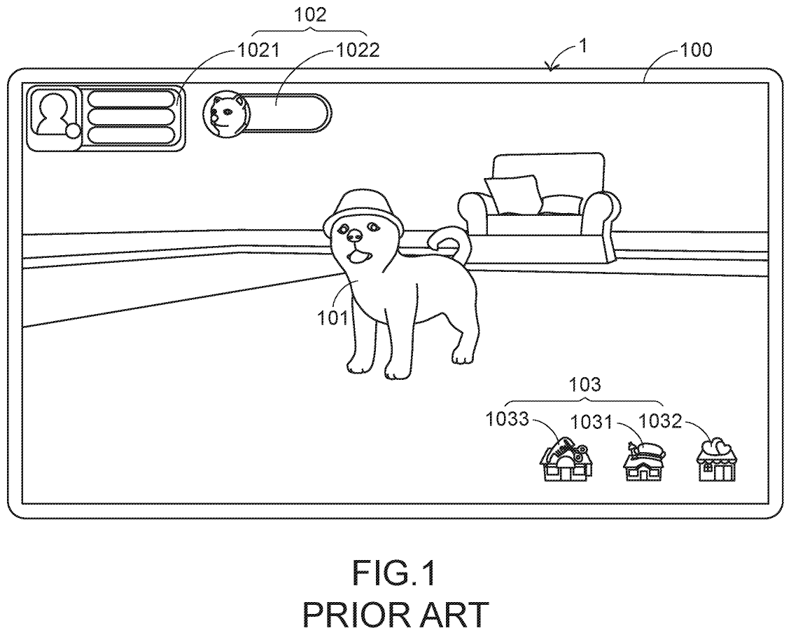

FIG. 2 is a schematic functional block diagram illustrating an interactive gaming system according to an embodiment of the present invention;

FIG. 3 schematically illustrates a screen image shown on the display device of the interactive gaming system according to the embodiment of the present invention when the gaming software is executed;

FIG. 4 schematically illustrates a screen image shown on the display device of the interactive gaming system according to the embodiment of the present invention when a game character enters the scene image;

FIG. 5 schematically illustrates a screen image shown on the display device of the interactive gaming system according to the embodiment of the present invention when the user image appears in the scene image; and

FIG. 6 schematically illustrates a screen image shown on the display device of the interactive gaming system according to the embodiment of the present invention when the user image and the game character appear in the scene image.

### DETAILED DESCRIPTION OF THE PREFERRED EMBODIMENT

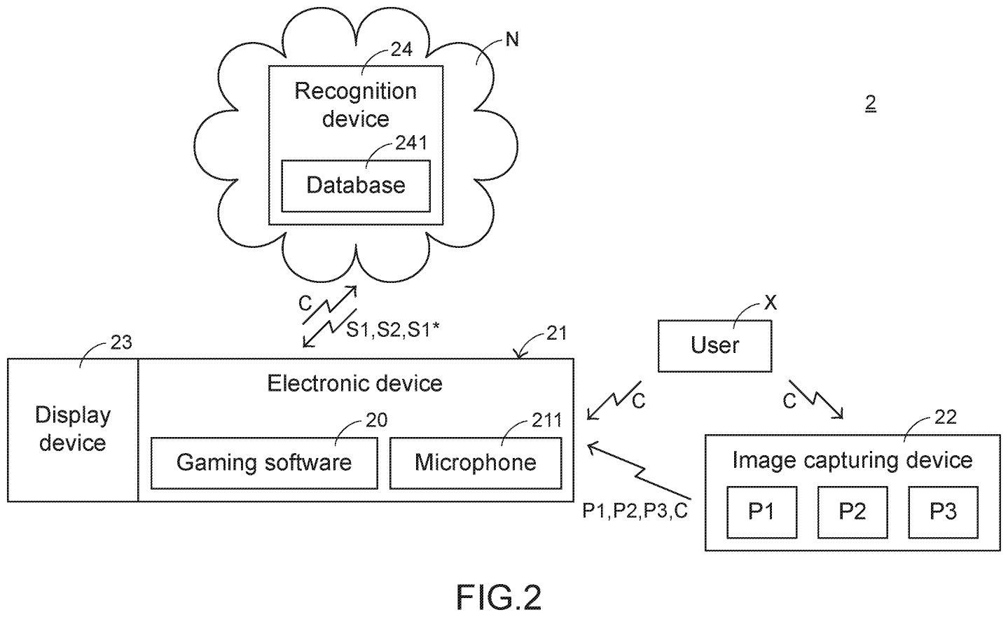

The present invention provides an interactive gaming system. FIG. 2 is a schematic functional block diagram illustrating an interactive gaming system according to an embodiment of the present invention. As shown in FIG. 2, the interactive gaming system 2 comprises an electronic device 21, an image capturing device 22, a display device 23 and a recognition module 24. A gaming software 20 is executed in the electronic device 21. The electronic device 21 can receive an operating command from a user X. The image capturing device 22 is in communication with the electronic device 21. The image capturing device 22 is used for shooting a scene to acquire a scene image P1 or shooting the user X to acquire a user image P2. The display device 23 is connected with the electronic device 21 for displaying the scene image P1, the user image P2 and a game character 200 corresponding to the gaming software 20. The recognition module 24 is connected with the electronic device 21. After the operating command is received and recognized by the recognition module 24, an operating signal S1 corresponding to the operating command is transmitted from the recognition module 24 to the electronic device 21. According to the operating signal S1, the game character 200 in the scene image P1 performs a corresponding action. In an embodiment, the display device 23 is a display screen.

As shown in FIG. 2, the recognition module 24 comprises a database 241. In addition, plural predetermined commands (not shown) are stored in the database 241. When receiving the operating command, the recognition module 24 compares the operating command with the plural predetermined commands in the database 241. Moreover, the recognition module 24 judges whether the operating command complies with at least one of the plural predetermined commands. According to the judging result, the recognition module 24 performs a corresponding operation. For example, if the recognition module 24 judges that the operating command complies with at least one of the plural predetermined commands, the operating signal S1 corresponding to the operating command is transmitted from the recognition module 24 to the electronic device 21 in a network transmission manner. Whereas, if the recognition module 24 judges that the operating command does not comply with all of the plural predetermined commands, the recognition module 24 issues a prompt signal S2 to the electronic device 21 in the network transmission manner in order to prompt the user X to provide the operating command again.

In this embodiment, the recognition module 24 is installed in a network N. In addition, the recognition module 24 is in wireless communication with the electronic device 21 through network connection. It is noted that numerous modifications may be made while retaining the teachings of the present invention. For example, in another embodiment, the recognition module is disposed within the electronic device and connected with the electronic device through wired connection.

The electronic device 21 further comprises a microphone 211. The microphone 211 is disposed within the electronic device 21. The microphone 211 may receive the operating command from the user X. In an embodiment, the operating command is issued to the microphone 211 of the electronic device 21 in a form of a sound. Then, the received operating command is further transmitted from the electronic device 21 to the recognition module 24. The recognition module 24 recognizes the operating command through a sound recognition technology. On the other hand, the display device 23 comprises a touch module 231. When the touch module 231 is touched by the user, a corresponding operating command is generated. Then, operating command is transmitted from the display device 23 to the electronic device 21. After receiving the operating command, the recognition module 24 recognizes the operating command through a touch signal recognition technology. Due to the arrangement of the touch module 231, the display device 23 may be considered as a touch screen.

In an embodiment, the display device 23 and the microphone 211 are integrated into the electronic device 21, and the electronic device 21 is a smart phone or a tablet computer. It is noted that numerous modifications and alterations may be made while retaining the teachings of the invention. For example, in another embodiment, the display device and the microphone are externally connected with the electronic device, and the electronic device is a game console.

As mentioned above, the electronic device 21 can be used as a component for receiving the operating command. In some other embodiments, the operating command are obtained through the image capturing device 22. A process of obtaining the operating command through the image capturing device 22 will be described as follows.

At the time when the image capturing device 22 acquires the user image P2, the operating command is also obtained and transmitted to the electronic device 21. Then, the operating command is transmitted from the electronic device 21 to the recognition module 24. Then, the recognition module 24 recognizes the gesture of the user image P2. If the recognition module 24 judges that the gesture of the user image P2 complies with at least one of the plural predetermined commands in the database 241, the gesture of the user image P2 is determined as an operating command by the recognition module 24. Then, the operating command or the recognition result notification is transmitted from the recognition module 24 to the electronic device 21. Consequently, the electronic device 21 controls the game character 200 to perform the action according to the operating command.

In an embodiment, the image capturing device 22 is a camera or a video camera. Moreover, the image capturing device 22 is in communication with the electronic device 21 through a wireless communication technology (e.g., through a Wi-Fi or Bluetooth technology). It is noted that numerous modifications or alternations may be made while retaining the teachings of the present invention. For example, in another embodiment, the image capturing device is connected with the electronic device through a connecting wire. Alternatively, the image capturing device is a built-in camera module of the electronic device. Preferably, the image capturing device is a panoramic camera to provide a wider range of scene image, and thus the richness and interesting efficacy of playing the game are enhanced.

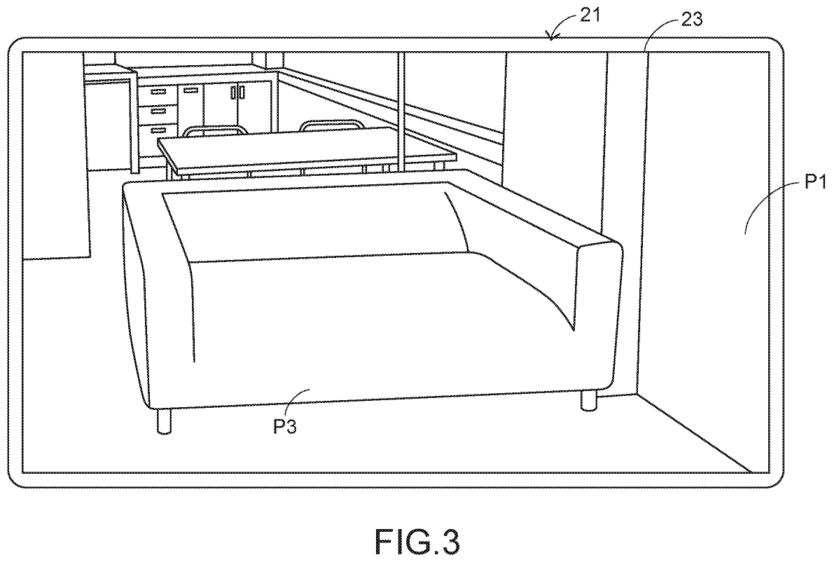

The operations of the interactive gaming system 2 will be illustrated as follows. For example, the interactive gaming system 2 is operated to play a pet game. Please refer to FIGS. 2 and 3. FIG. 3 schematically illustrates a screen image shown on the display device of the interactive gaming system according to the embodiment of the present invention when the gaming software is executed. Before the interactive gaming system 2 is enabled, the image capturing device 22 and the electronic device 21 are placed in a scene. After the interactive gaming system 2 is enabled, the image capturing device 22 shoots the scene to acquire the scene image P1. The scene image P1 is transmitted to the display device 23 through the electronic device 21. Consequently, the scene image P1 is shown on the display device 23. As shown in FIG. 3, the scene image P1 contains an object image P3 (e.g., the image of a sofa). Then, the gaming software 20 is executed in the electronic device 21, and the game is started. After the game is started, the game character 200 (i.e., the pet) corresponding to the gaming software 20 is activated. Hereinafter, some gaming scenarios will be described.

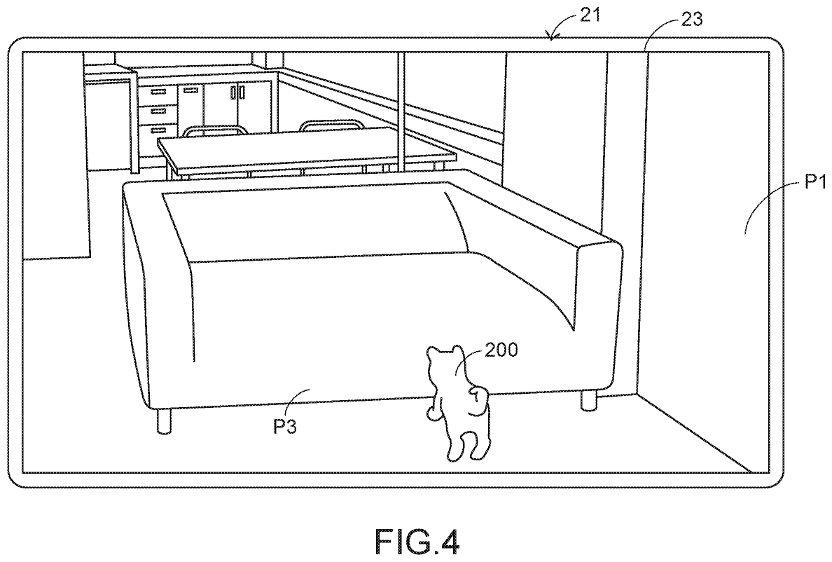

In a first gaming scenario, the operating command is issued in a form of a sound. For example, the user X calls the name of the pet. Meanwhile, the user X provides an audio-type operating command. After the microphone 211 of the electronic device 21 receives the audio-type operating command, the operating command is transmitted to the recognition module 24 in the network transmission manner. The recognition module 24 recognizes the operating command through a sound recognition technology. It is assumed that a predetermined command corresponding to the name of the pet has been stored in the database 241 of the recognition module 24. Consequently, the recognition module 24 judges that the operating command complies with the predetermined command. Meanwhile, the operating signal S1 corresponding to the operating command is transmitted from the recognition module 24 to the electronic device 21 in the network transmission manner. According to the operating signal S1, the electronic device 21 controls the game character 200 to enter the scene image P1 from the outside of the scene image P1. As shown in FIG. 4, the game character 200 appears in the scene image P1 after the user X calls the name of the pet.

In case that the sound volume of the audio-type operating command is too low or the sound of the audio-type operating command is blurred, the recognition module 24 judges that the operating command does not comply with all of the plural predetermined commands. Meanwhile, the recognition module 24 issues a prompt signal S2 to the electronic device 21 in the network transmission manner. For example, the prompt signal S2 is a sound prompt signal or an image prompt signal for prompting the user X to provide the operating command again.

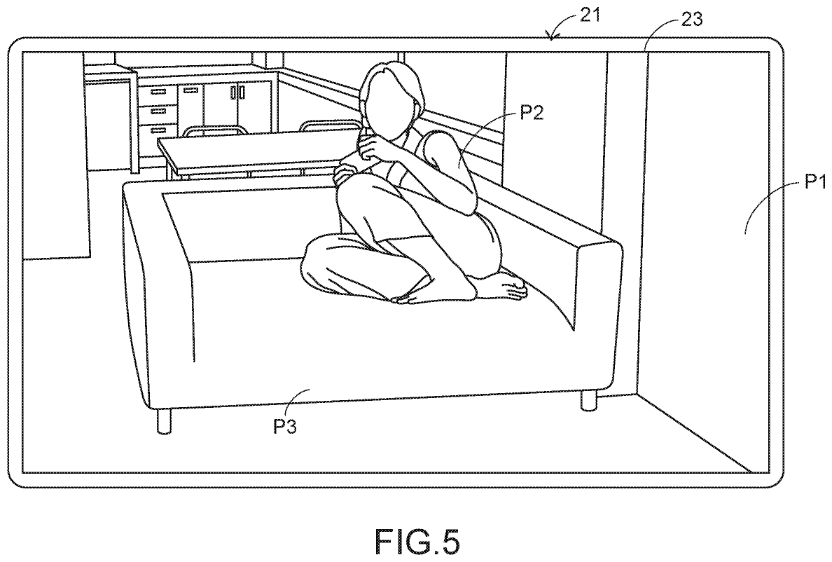

In a second gaming scenario, the operating command is issued in a form of a gesture. After the scene image P1 is shown on the display device 23, the user X enters the scene and sits on a sofa in the scene. Meanwhile, the image capturing device 22 acquires the user image P2. As shown in FIG. 5, the user image P2 sitting on the object image P3 of the scene image P1 is shown on the display device 23. In case that the user X creates an action of tapping the sofa, the image capturing device 22 acquires the user image P2 containing the operating command according to the action of the user X. In other words, the gesture of tapping the sofa in the user image P2 is the operating command.

Then, the operating command is transmitted from the image capturing device 22 to the recognition module 24 through the electronic device 21 in the network transmission manner. The recognition module 24 recognizes the operating command through a gesture recognition technology. It is assumed that a predetermined command corresponding to the tapping gesture has been stored in the database 241 of the recognition module 24. Consequently, the recognition module 24 judges that the operating command complies with the predetermined command.

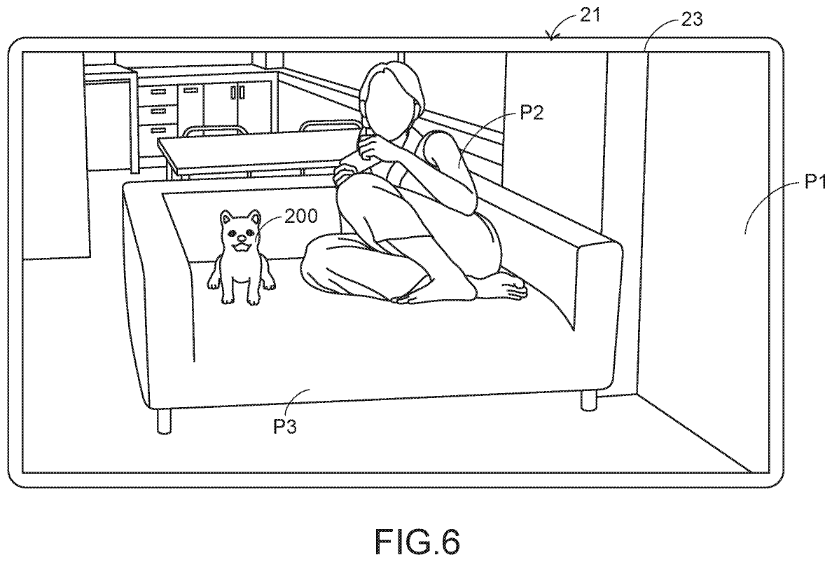

Meanwhile, the operating signal S1* corresponding to the operating command is transmitted from the recognition module 24 to the electronic device 21 in the network transmission manner. According to the operating signal S1*, the electronic device 21 controls the game character 200 to enter the scene image P1 and sit on the object image P3. As shown in FIG. 6, the game character 200 sits beside the user image P2. In case that the gesture of the user X is created very fast or the gesture is not clear, the recognition module 24 is unable to recognize the gesture. Meanwhile, the subsequent process is similar to that of the first gaming scenario, and is not redundantly described herein.

The following three aspects should be specially described. Firstly, the operations of the touch module to play games are similar to the conventional technology, and are not redundantly described herein. Secondly, the interactive gaming system of the above embodiment comprises both of the touch module and the microphone. It is noted that at least one component for receiving the operating command is feasible. For example, in another embodiment, the interactive gaming system is not equipped with the touch module and the microphone. Under this circumstance, the image capturing device is the only component for receiving the operating command from the user. Thirdly, in the interactive gaming system of the present invention, the type of the gaming software and the types of the gaming scenarios are not restricted. In the above embodiment, two gaming scenarios are taken as the examples for describing the operations of the interactive gaming system. It is noted that the types of the operating command and the gaming software for providing the interaction between the user and the game character are not restricted.

From the above descriptions, the present invention provides the interactive gaming system. The image capturing device acquires the user image corresponding to the user. The user image is shown on the display device. Moreover, the operating command from the user is obtained through the electronic device or the image capturing device. Afterwards, the operating command is recognized by the recognition module. According to the recognition result of the recognition module, the game character in the gaming software performs a corresponding action. Consequently, the user can see that the user image and the game character are simultaneously shown on the same screen image of the display device. Moreover, the game character can perform the corresponding action according to the sound or gesture of the user. When compared with the conventional technology of using the joystick or the operation controller to play games, the interactive gaming system of the present invention allows the user to have the feel in the virtual situation and provides highly interesting efficacy to the user.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interactive gaming system, comprising:
an electronic device executing a gaming software and receiving an operating command from a user;
an image capturing device in communication with the electronic device, wherein the image capturing device shoots a scene to acquire a scene image, or the image capturing device shoots the user to acquire a user image;
a display device connected with the electronic device, wherein the scene image, the user image and a game character corresponding to the gaming software are displayed on the display device; and
a recognition module connected with the electronic device, wherein after the recognition module receives and recognizes the operating command, an operating signal corresponding to the operating command is transmitted from the recognition module to the electronic device, and the game character in the scene image performs a corresponding action according to the operating signal.

2. The interactive gaming system according to claim 1, wherein the recognition module comprises a database, and plural predetermined commands are stored in the database, wherein when the recognition module receives the operating command, the recognition module compares the operating command with the plural predetermined commands in the database, wherein if the recognition module judges that the operating command complies with at least one of the plural predetermined commands, the operating signal corresponding to the operating command is transmitted from the recognition module to the electronic device, wherein if the recognition module judges that the operating command does not comply with all of the plural predetermined commands, the recognition module issues a prompt signal to the electronic device.

3. The interactive gaming system according to claim 2, wherein the recognition module is installed in a network, and the recognition module is in wireless communication with the electronic device through network connection.

4. The interactive gaming system according to claim 2, wherein the recognition module is disposed within the electronic device and connected with the electronic device through wired connection.

5. The interactive gaming system according to claim 1, wherein when a gesture corresponding to the operating command is contained in the user image, the operating command is transmitted from the image capturing device to the electronic device, wherein the recognition module recognizes the operating command according to a result of recognizing the gesture of the user image.

6. The interactive gaming system according to claim 1, wherein the electronic device comprises a microphone to receive the operating command, wherein the operating command is issued to the microphone of the electronic device in a form of a sound, and the recognition module recognizes the operating command through a sound recognition technology.

7. The interactive gaming system according to claim 1, wherein the display device comprises a touch module, wherein when the touch module is touched by the user, the operating command is generated and the operating command is transmitted from the display device to the electronic device, wherein the recognition module recognizes the operating command through a touch signal recognition technology.

8. The interactive gaming system according to claim 7, wherein the display device is integrated into the electronic device, and the electronic device is a game console, a smart phone or a tablet computer.

9. The interactive gaming system according to claim 1, wherein the image capturing device is a camera, a video camera or a panoramic camera.

10. The interactive gaming system according to claim 1, wherein the image capturing device is in communication with the electronic device through wired connection or wireless connection.
